(19) United States
(12) Patent Application Publication
(10) Pub. No.: US 2017/0327617 A1
(43) Pub. Date: Nov. 16, 2017

(54) ELASTOMER LAMINATE COMPRISING THREE LAYERS

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: José-Carlos ARAUJO DA SILVA, Clermont-Ferrand Cedex 9 (FR); Aurélie TRIGUEL, Clermont-Ferrand Cedex 9 (FR); Mathilde ABAD, Clermont-Ferrand Cedex 9 (FR)

(21) Appl. No.: 15/532,305

(22) PCT Filed: Nov. 23, 2015
(86) PCT No.: PCT/EP2015/077350

§ 371 Date: Jun. 1, 2017

(30) Foreign Application Priority Data
Dec. 2, 2014 (FR) 1461755

(51) Int. Cl. C08F 236/06; B60C 1/00; B32B 27/08; B32B 27/32; C08F 232/04; C08F 210/02

(52) U.S. Cl. CPC C08F 236/06; C08F 232/04; C08F 210/02; B32B 27/08; B32B 27/325; B60C 1/0025

(57) ABSTRACT

An elastomer laminate comprising three layers is provided. The first layer consists of a diene rubber composition comprising a first elastomer matrix, the second layer consists of a diene rubber composition comprising a second elastomer matrix, which second elastomer matrix comprises a second elastomer comprising ethylene units and diene units comprising a carbon-carbon double bond, which units are randomly distributed within the second elastomer, and the third layer consists of a diene rubber composition comprising a third diene elastomer having a content by weight of diene units of greater than 50% The second layer is arranged between the first layer and the third layer. Such a laminate has good resistance to separation of the layers which constitute it.

This application is a 371 national phase entry of PCT/EP2015/077350, filed on 23 Nov. 2015, which claims benefit of French Patent Application No. 1461755, filed 2 Dec. 2014, the entire contents of which are incorporated herein by reference for all purposes.

### BACKGROUND

### 1. Technical Field

The present invention relates to elastomer laminates comprising 3 layers of diene rubber composition, intended in particular to be used in a tire.

### 2. Related Art

A tire usually comprises a tread, two sidewalls, two beads, a carcass reinforcement passing into the two sidewalls and anchored to the two beads, and a crown reinforcement arranged circumferentially between the tread and the carcass reinforcement. The tread is intended to come into contact with the surface on which the tire runs. The tire may also comprise a tread underlayer, the underlayer being arranged circumferentially between the tread and the carcass reinforcement, preferably between the tread and the crown reinforcement, the tread underlayer generally being adjacent to the tread.

In the tire, the tread underlayer must adhere to the tread sufficiently in order to avoid the underlayer at the surface of the tread from detaching from the tread for the entire life of the tire. The underlayer generally adheres to the tread by means of physical or chemical phenomena, such as phenomena of interpenetration, entanglement or crosslinking of the diene rubber compositions constituting the tread and the tread underlayer, respectively. Under the conditions suitable for processing and curing diene rubber compositions placed against one another, these compositions are solidly bonded together and the complex obtained makes it possible to withstand the stresses associated with the field of application in question, especially that of tires.

The compositions which may be used in a tread may contain an elastomer matrix which has a low degree of unsaturation or which comprises a terpolymeric elastomer of ethylene, of an α-olefin and of a non-conjugated diene. An elastomer matrix is considered to have a low degree of unsaturation when it contains less than 10% by weight of diene units. Generally, the rubber composition of a tread underlayer is generally based on an elastomer matrix which comprises natural rubber, considered to be a highly unsaturated elastomer. However, the level of adhesion between, on the one hand, a first composition based on an elastomer matrix which has a low degree of unsaturation or which contains a terpolymeric elastomer of ethylene, of an α-olefin and of a non-conjugated diene, and on the other hand a second composition based on an elastomer matrix containing a highly unsaturated elastomer, may be deemed to be insufficient, especially for an application, in tires, of the first composition as tire tread and of the second composition as tread underlayer.

To overcome this, it is possible to use a material which will serve as bonding rubber or adhesive for bonding between the first composition and the second composition, especially used, respectively, as tire tread and tread underlayer. In this case, the tread underlayer is no longer adjacent over its entire length to the tread, but is separated therefrom by the bonding rubber.

### SUMMARY

The Applicants have solved the problem by using a diene rubber composition which serves as bonding rubber between these two compositions. Used as intermediate layer between the two compositions which each constitute a layer in a laminate, it makes it possible to significantly improve the resistance of the laminate to separation of the layers which constitute it.

Thus, a first subject of the invention is an elastomer laminate comprising 3 layers,
the first layer consisting of a diene rubber composition comprising a first elastomer matrix,
the second layer consisting of a diene rubber composition comprising a second elastomer matrix, which second elastomer matrix comprises a second elastomer comprising ethylene units and diene units comprising a carbon-carbon double bond, which units are randomly distributed within the second elastomer,
the third layer consisting of a diene rubber composition comprising a third diene elastomer having a content by weight of diene units of greater than 50%,
the second layer being arranged between the first layer and the third layer.

Another subject of the invention is the use of the laminate in a tire.

The invention also relates to a tire which comprises the laminate.

The invention also relates to the use of an adhesive composition identical to the diene rubber composition constituting the second layer of the laminate, to adhere a diene rubber composition identical to that constituting the first layer of the laminate to a diene rubber composition identical to that constituting the third layer of the laminate.

### DETAILED DESCRIPTION OF EXAMPLE EMBODIMENTS

The expression composition “based on” should be understood as meaning a composition comprising the mixture and/or the reaction product of the various constituents used, some of these base constituents being capable of reacting, or intended to react, with one another, at least in part, during the various phases of manufacture of the composition, in particular during the crosslinking or vulcanization thereof.

The expression “part by weight per hundred parts by weight of elastomer” (or phr) should be understood as meaning, within the context of embodiments of the present invention, the portion by weight per hundred parts of elastomer present in the rubber composition in question and constituting a layer.

In the present description, unless expressly indicated otherwise, all the percentages (%) shown are percentages (%) by weight. Furthermore, any range of values denoted by the expression “between a and b” represents the range of values extending from more than a to less than b (that is to say, limits a and b excluded), whereas any range of values denoted by the expression “from a to b” means the range of values extending from a up to b (that is to say, including the strict limits a and b).

“Laminate” is intended to mean a product made of several layers, of planar or non-planar shape, in accordance with the definition given by the International Patent Classification.

The elastomer laminate in accordance with embodiments of the invention comprises 3 layers,
the first layer consisting of a diene rubber composition comprising a first elastomer matrix,
the second layer consisting of a diene rubber composition comprising a second elastomer matrix, which second elastomer matrix comprises a second elastomer comprising ethylene units and diene units comprising a carbon-carbon double bond, which units are randomly distributed within the second elastomer,
the third layer consisting of a diene rubber composition comprising a third diene elastomer having a content by weight of diene units of greater than 50%,
the second layer being arranged between the first layer and the third layer.

The laminate in accordance with embodiments of the invention is said to be elastomeric since it comprises 3 layers consisting of diene rubber compositions.

The laminate preferably consists of 3 layer defined according to any one of the embodiments of the invention.

By virtue of the nature of the elastomers which compose it, the diene rubber composition which constitutes the second layer is different from the diene rubber composition of the first layer and is different from the diene rubber composition of the third layer.

A “diene” elastomer (or “rubber”, the two terms being considered to be synonymous) should be understood, in a known way, to mean an (one or more is understood) elastomer resulting at least in part (i.e., a homopolymer or a copolymer) from diene monomers (monomers bearing two carbon-carbon double bonds which may or may not be conjugated).

A highly unsaturated diene elastomer is an elastomer having a content by weight of diene units of greater than 50%.

A diene elastomer which has a low degree of unsaturation is an elastomer having a content by weight of diene units of less than 10%.

The content of diene units related to an elastomer is expressed as percentage by weight per 100 g of the elastomer. It is therefore a content by weight. For example, a content by weight of diene units of x % in an elastomer A means that the diene units represent x g in 100 g of elastomer A, x being a number from 0 to 100, for example equal to 5. This formulation is equivalent to saying that elastomer A contains x % of diene units, or that elastomer A exhibits x % of diene units, or else that elastomer A has x % of diene units.

A diene unit is a monomer unit originating from the insertion of a monomer subunit resulting from the polymerization of a conjugated diene monomer or of a non-conjugated diene monomer, the diene unit comprising a carbon-carbon double bond.

An elastomer matrix of a rubber composition is all the elastomers contained in the rubber composition.

A highly unsaturated elastomer matrix is an elastomer matrix having a content by weight of diene units of greater than 50%. A highly unsaturated elastomer matrix typically contains one (or several) highly unsaturated diene elastomers having a content by weight of diene units of greater than 50%. By way of example, mention may be made of the homopolymeric elastomers and copolymers of 1,3-diene, especially butadiene or isoprene.

An elastomer matrix which has a low degree of unsaturation is an elastomer matrix having a content by weight of diene units of less than 10%. An elastomer matrix which has a low degree of unsaturation typically contains one (or several) diene elastomers which have a low degree of unsaturation having a content by weight of diene units of less than 10%. The elastomer matrix which has a low degree of unsaturation may nonetheless contain a highly unsaturated diene elastomer in a proportion such that the content by weight of diene units present in the elastomer matrix is less than 10%.

The content of diene units related to an elastomer matrix is expressed as percentage by weight per 100 g of the elastomer matrix. It is therefore a content by weight. For example, a content by weight of diene units of y % in an elastomer matrix B means that all the diene units present in elastomer matrix B represent y g in 100 g of elastomer matrix B, y being a number from 0 to 100, for example equal to 10. This formulation is equivalent to saying that elastomer matrix B contains y % of diene units, or that elastomer matrix B has y % of diene units.

Second Elastomer Matrix:

The second elastomer matrix has the essential feature of comprising a second elastomer comprising ethylene units and diene units comprising a carbon-carbon double bond, which units are randomly distributed within the second elastomer.

According to any one of the embodiments of the invention, the diene units comprising a carbon-carbon double bond and present in the second elastomer are preferably 1,3-diene units having 4 to 12 carbon atoms, especially 1,3-butadiene units.

According to one embodiment of the invention, the ethylene units present in the second elastomer represent at least 50 mol % of all the monomer units of the second elastomer.

According to a particular embodiment of the invention, the second elastomer comprises the following units UA, UB, UC and UD randomly distributed within the second elastomer, UA) —CH₂—CH₂— according to a molar percentage of m % UB) according to a molar percentage of n %

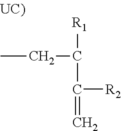

according to a molar percentage of o %

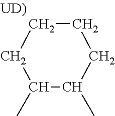

according to a molar percentage of p %
R₁ and R₂, which are identical or different, denoting a hydrogen atom, a methyl radical or a phenyl radical which is unsubstituted or substituted in the ortho, meta or para position by a methyl radical,
m≧50
0<o+p≦25
n+o>0
m, n, o and p being numbers ranging from 0 to 100
the respective molar percentages of m, n, o and p being calculated on the basis of the sum of m+n+o+p, which is equal to 100.

According to another particular embodiment of the invention, the second elastomer contains units UE randomly distributed within the second elastomer:

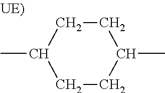

according to a molar percentage of q %
o+p+q≧10
q≧0
the respective molar percentages of m, n, o, p and q being calculated on the basis of the sum of m+n+o+p+q, which is equal to 100.

Whereas the subunit of the unit UD forms a divalent hydrocarbon ring comprising 6 carbon atoms of 1,2-cyclohexane type, the subunit of the unit UE forms a divalent hydrocarbon ring comprising 6 carbon atoms of 1,4-cyclohexane type.

According to another embodiment of the invention, the second elastomer contains units UF randomly distributed within the second elastomer,

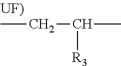

according to a molar percentage of r %
R₃ denoting an alkyl radical having from 1 to 4 carbon atoms or an aryl radical,
0≦r≦25, preferably 0≦r≦10,
the respective molar percentages of m, n, o, p and r being calculated on the basis of the sum of m+n+o+p+r, which is equal to 100.

According to this particular embodiment of the invention, the second elastomer can comprise q % of units UE randomly distributed within the second elastomer, in which case the respective molar percentages of m, n, o, p, q and r are calculated on the basis of the sum of m+n+o+p+q+r, which is equal to 100.

It is understood that the second elastomer can consist of a mixture of elastomers which contain the units UA, UB, UC, UD, UE and UF according to the respective molar percentages m, n, o, p, q and r as defined above and which differ from one another in their macrostructure or their microstructure, in particular in the respective molar contents of the units UA, UB, UC, UD, UE and UF.

According to any one of the embodiments of the invention, the second elastomer preferably does not contain a unit UF.

According to one embodiment of the invention, at least one of the two molar percentages p and q is preferably different from 0. In other words, the second diene elastomer preferably contains at least one of the subunits which are a divalent hydrocarbon ring comprising 6 carbon atoms of 1,2-cyclohexane type and a divalent hydrocarbon ring comprising 6 carbon atoms of 1,4-cyclohexane type. More preferentially, p is strictly greater than 0.

According to one embodiment of the invention, the second elastomer has at least one, and preferentially all, of the following criteria:
m≧65
n+o+p+q≧15, more preferably still 20
10≧p+q≧2
1≧n/(o+p+q)
when q is non-zero, 20≧p/q≧1.

According to another preferential embodiment of the invention, the second elastomer contains, as monomer units, only the units UA, UB, UC, UD and UE according to their respective molar percentages m, n, o, p and q, preferably all different from 0.

According to another preferential embodiment of the invention, the second elastomer contains, as monomer units, only the units UA, UB, UC and UD according to their respective molar percentages m, n, o and p, preferably all different from 0.

According to any one of the embodiments of the invention, the units UB present in the second elastomer preferably have the trans configuration represented by the following formula:

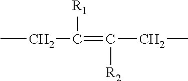

According to any one of the embodiments of the invention, the second elastomer preferably has a number-average molar mass (Mn) of at least 60 000 g/mol and of at most 1 500 000 g/mol. The starting diene polymer useful for the requirements of embodiments of the invention preferably has a polydispersity index PI, equal to Mw/Mn (Mw being the weight-average molar mass), of between 1.20 and 3.00. The Mn, Mw and PI values are measured according to the method described in section 11.2-b).

The second elastomer can be obtained according to various methods of synthesis known to those skilled in the art, especially as a function of the targeted values of m, n, o, p, q and r. Generally, the second elastomer can be prepared by copolymerization of at least one conjugated diene monomer and of ethylene and according to known methods of synthesis, in particular in the presence of a catalytic system comprising a metallocene complex. In this respect, mention may be made of the catalytic systems based on metallocene complexes, which catalytic systems are described in the documents EP 1 092 731 A1, EP 1 554 321 A1, EP 1 656 400 A1, EP 1 829 901 A1, EP 1 954 705 A1 and EP 1 957 506 A1 in the name of the Applicants.

A conjugated diene having from 4 to 12 carbon atoms is especially suitable as conjugated diene monomer. Mention may be made of 1,3-butadiene, 2-methyl-1,3-butadiene, 2,3-dimethyl-1,3-butadiene, an aryl-1,3-butadiene or 1,3-pentadiene. According to a preferential aspect, the diene monomer is 1,3-butadiene or 2-methyl-1,3-butadiene, more preferentially 1,3-butadiene, in which case R₁ and R₂ each represent a hydrogen.

Thus, according to some of these methods of synthesis, the second elastomer can be obtained by copolymerization of at least one conjugated diene monomer and of ethylene, in the presence of a catalytic system comprising a lanthanide metallocene complex with ansa ligands of fluorenyl type. In this respect, mention may be made of the metallocene complexes described in the documents EP 1 092 731 A1, EP 1 554 321 A1 and EP 1 954 705 A1.

The second elastomer which contains units UF according to a particular embodiment of the invention can be obtained by copolymerization of at least one conjugated diene monomer and of two olefins, such as ethylene and an α-olefin, in the presence of a catalytic system comprising a lanthanide metallocene complex with ligands of ansa cyclopentadienyl-fluorenyl type. For example, an α-olefin having from 3 to 18 carbon atoms, advantageously having from 3 to 6 carbon atoms, is suitable as α-olefin monomer. Mention may be made of propylene, butene, pentene, hexene or a mixture of these compounds. Mention may also be made, as termonomer used in combination with at least one conjugated diene monomer and ethylene, of a styrene derivative. The catalytic systems based on metallocene complexes can be those described in the documents EP 1 092 731 A1, EP 1 656 400 A1, EP 1 829 901 A1 and EP 1 957 506 A1 in the name of the Applicants.

The second elastomer can be prepared in accordance with the abovementioned documents by adjusting the polymerization conditions by means known to those skilled in the art, so as to achieve number-average molar mass (Mn) values of at least 60 000 g/mol. By way of illustration, the polymerization time may be significantly increased so that the monomer conversion is greater, thereby leading to molar masses of at least 60 000 g/mol being obtained. By way of illustration, during the preparation of the catalytic systems according to the abovementioned documents, the stoichiometry of the alkylating agent with respect to the metallocene complex(es) is reduced, so as to reduce chain transfer reactions and to make it possible to obtain molar masses of at least 60 000 g/mol.

In addition to the second elastomer, the second elastomer matrix may comprise another diene elastomer, in particular a highly unsaturated diene elastomer. Mention may be made, as highly unsaturated elastomer, of those containing conjugated diene monomer units, in particular 1,3-diene having 4 to 12 carbon atoms. The homopolymers and copolymers of butadiene and of isoprene are more particularly suitable. Advantageously, this other diene elastomer is a polyisoprene, preferentially a polyisoprene with a high cis content, having a degree of 1,4-cis bonding of greater than 90%, more preferentially natural rubber.

When the second elastomer matrix comprises another highly unsaturated diene elastomer, the weight fraction of this other diene elastomer in the second diene elastomer matrix varies preferentially from 10 to 70% (of the weight of the second elastomer matrix).

According to a particular embodiment of the invention, the second elastomer matrix consists of the second elastomer and this other highly unsaturated diene elastomer.

According to another embodiment of the invention, the second elastomer represents more than 50% by weight of the second elastomer matrix, preferably more than 90% by weight of the second elastomer matrix, better still the entirety of the second elastomer matrix.

First Elastomer Matrix:

According to one embodiment of the invention, the first elastomer matrix comprises a terpolymer of ethylene, of an α-olefin and of a non-conjugated diene, hereinafter denoted the first elastomer or else referred to as the first terpolymeric elastomer of ethylene, of an α-olefin and of a non-conjugated diene.

According to a particular embodiment of the invention, the first elastomer has at least one and preferably all, of the following characteristics:
the ethylene units represent between 20 and 90%, preferentially between 30 and 70%, by weight of the second elastomer,
the α-olefin units represent between 10 and 80%, preferentially from 15 to 70%, by weight of the second elastomer,
the non-conjugated diene units represent between 0.5 and 10% by weight of the first elastomer.

According to a preferential embodiment of the invention, the first elastomer has a content by weight of diene units which is less than the content by weight of diene units of the second elastomer.

According to a more preferential embodiment of the invention, the first elastomer has a content by weight of diene units of less than 10%.

According to one embodiment of the invention, the first elastomer represents more than 50% by weight of the first elastomer matrix, preferably all of the first elastomer matrix.

According to another embodiment of the invention, the first elastomer matrix has a content by weight of diene units which is less than the content by weight of diene units of the second elastomer. For example, according to this embodiment of the invention, if the content by weight of diene units of the second elastomer is 14%, the content by weight of diene units of the first elastomer matrix is less than 14%, for example is of the order of 5%.

According to a particular embodiment of the invention, the first elastomer matrix has a content by weight of diene units which is less than the content by weight of diene units of the second elastomer and comprises the first terpolymeric elastomer of ethylene, of an α-olefin and of a non-conjugated diene.

According to another embodiment of the invention, the first elastomer matrix has less than 10% by weight of diene units and preferably comprises the first terpolymeric elastomer of ethylene, of an α-olefin and of a non-conjugated diene. The elastomer matrix is considered to be a matrix which has a low degree of unsaturation.

It is understood that the first elastomer may be a mixture of terpolymers of ethylene, of α-olefin and of non-conjugated diene which differ from one another in their macrostructure or their microstructure, in particular in the respective contents by weight of the ethylene, α-olefin and non-conjugated diene units.

The α-olefin, the monomer units of which constitute the first elastomer, may be a mixture of α-olefins. The α-olefin generally comprises from 3 to 16 carbon atoms. Suitable as α-olefin are, for example, propylene, 1-butene, 1-pentene, 1-hexene, 1-octene and 1-dodecene. Advantageously, the α-olefin is propylene, in which case the terpolymer is commonly referred to as an EPDM rubber.

The non-conjugated diene, the monomer units of which constitute the first elastomer or the second elastomer, generally comprises from 6 to 12 carbon atoms. Mention may be made, as non-conjugated diene, of dicyclopentadiene, 1,4-hexadiene, 5-ethylidene-2-norbornene, 5-methylene-2-norbornene or 1,5-cyclooctadiene. Advantageously, the non-conjugated diene is 5-ethylidene-2-norbornene.

The first elastomer is preferably a terpolymer of ethylene, of propylene and of 5-ethylidene-2-norbornene.

Third Diene Elastomer:

The third diene elastomer has the essential feature of having a content by weight of diene units of greater than 50%. The third diene elastomer may be an elastomer containing conjugated diene monomer units, in particular 1,3-diene containing 4 to 12 carbon atoms, advantageously isoprene.

It is understood that the third diene elastomer may be a mixture of elastomers which differ from one another in their macrostructure or their microstructure.

According to a preferential embodiment of the invention, the third diene elastomer is a polyisoprene. The polyisoprene as third diene elastomer is preferably a polyisoprene having a degree of 1,4-cis bonding of greater than 90%, which percentage is calculated on the basis of the weight of the polyisoprene. Advantageously, the third diene elastomer is natural rubber.

According to one embodiment of the invention, the third diene elastomer, advantageously polyisoprene or very advantageously natural rubber, represents at least 95% by weight, preferably all, of the elastomer matrix which constitutes the diene rubber composition of the third layer.

The microstructure of the elastomers is determined by ¹H NMR analysis, supplemented by ¹³C NMR analysis when the resolution of the ¹H NMR spectra does not enable the attribution and quantification of all the species. The measurements are carried out using a Bruker 500 MHz NMR spectrometer at frequencies of 500.43 MHz for observing protons and 125.83 MHz for observing carbons.

For the measurements of mixtures or elastomers which are insoluble but which have the ability to swell in a solvent, an HRMAS z-grad 4 mm probe is used, making it possible to observe protons and carbons in proton-decoupled mode. The spectra are acquired at spin speeds of 4000 Hz to 5000 Hz.

For the measurements of soluble elastomers, a liquid NMR probe is used, making it possible to observe protons and carbons in proton-decoupled mode.

The insoluble samples are prepared in rotors filled with the analyte and a deuterated solvent enabling swelling, in general deuterated chloroform (CDCl₃). The solvent used must always be deuterated and its chemical nature may be adapted by those skilled in the art. The amounts of analyte used are adjusted so as to obtained spectra with sufficient sensitivity and resolution.

The soluble samples are dissolved in a deuterated solvent (approximately 25 mg of elastomer in 1 ml), in general deuterated chloroform (CDCl₃). The solvent or solvent blend used must always be deuterated and its chemical nature may be adapted by those skilled in the art.

In both cases (soluble sample or swollen sample):

For the proton NMR, a simple 30° pulse sequence is used. The spectral window is adjusted to observe all the resonance lines belonging to the molecules analysed. The accumulation number is adjusted in order to obtain a signal to noise ratio that is sufficient for the quantification of each subunit. The recycle period between each pulse is adapted to obtain a quantitative measurement.

For the carbon NMR, a simple 30° pulse sequence is used with proton decoupling only during acquisition to avoid the “nuclear Overhauser” effects (NOE) and to remain quantitative. The spectral window is adjusted to observe all the resonance lines belonging to the molecules analysed. The accumulation number is adjusted in order to obtain a signal to noise ratio that is sufficient for the quantification of each subunit. The recycle period between each pulse is adapted to obtain a quantitative measurement.

The NMR measurements are carried out at 25° C.

Reinforcing Filler:

The diene rubber composition which constitutes any one of the 3 layers preferably comprises a reinforcing filler, in particular when the laminate is used in a tire.

The reinforcing filler may be any type of “reinforcing” filler known for its abilities to reinforce a diene rubber composition which may be used for the manufacture of tires, for example an organic filler, such as carbon black, a reinforcing inorganic filler, such as silica, with which is combined, in a known way, a coupling agent, or else a mixture of these two types of fillers.

Such a reinforcing filler typically consists of nanoparticles, the (weight-)average size of which is less than a micrometre, generally less than 500 nm, usually between 20 and 200 nm, in particular and more preferentially between 20 and 150 nm.

All carbon blacks, especially the blacks conventionally used in tires or their treads (“tire-grade” blacks), are suitable as carbon blacks. Among the latter, mention will more particularly be made of the reinforcing carbon blacks of the series 100, 200, 300, or the blacks of the series 500, 600 or 700 (ASTM grades), such as for example the blacks N115, N134, N234, N326, N330, N339, N347, N375, N550, N683, N772. These carbon blacks can be used in the isolated state, as commercially available, or in any other form, for example as support for some of the rubber additives used.

“Reinforcing inorganic filler” should be understood here as meaning any inorganic or mineral filler, irrespective of its colour and its origin (natural or synthetic), also known as “white” filler, “clear” filler or even “non-black” filler, in contrast to carbon black, capable of reinforcing, by itself alone, without means other than an intermediate coupling agent, a diene rubber composition intended for the manufacture of pneumatic tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferentially silica (SiO₂), are suitable in particular as reinforcing inorganic fillers. The silica used can be any reinforcing silica known to those skilled in the art, especially any precipitated or fumed silica having a BET surface area and a CTAB specific surface area both of less than 450 m²/g, preferably from 30 to 400 m²/g, especially between 60 and 300 m²/g. As highly dispersible precipitated silicas (“HDSs”), mention will be made, for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber and the silicas having a high specific surface area as described in application WO 03/016387.

In the present account, the BET specific surface area is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas:nitrogen—degassing: 1 hour at 160′C—relative pressure p/po range: 0.05 to 0.17). The CTAB specific surface area is the external surface area determined according to French Standard NF T 45-007 of November 1987 (method B).

The physical state in which the reinforcing inorganic filler is provided is unimportant, whether it is in the form of a powder, microbeads, granules or else beads. Of course, reinforcing inorganic filler is also understood to mean mixtures of various reinforcing inorganic fillers, in particular of highly dispersible silicas as described above.

Those skilled in the art will understand that use might be made, as filler equivalent to the reinforcing inorganic filler described in the present paragraph, of a reinforcing filler of another nature, especially organic, such as carbon black, provided that this reinforcing filler is covered with an inorganic layer, such as silica, or else comprises, at its surface, functional sites, especially hydroxyl sites, requiring the use of a coupling agent in order to establish the bond between the filler and the elastomer. Mention may be made, by way of example, of, for example, carbon blacks for tires, such as described, for example, in patent documents WO 96/37547 and WO 99/28380.

In order to couple the reinforcing inorganic filler to the diene elastomer, use is made, in a well-known way, of an at least bifunctional coupling agent, especially a silane, (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Use is especially made of silane polysulphides, referred to as “symmetrical” or “asymmetrical” depending on their specific structure, such as described, for example, in Applications WO 03/002648 (or US 2005/016651) and WO 03/002649 (or US 2005/016650).

Particularly suitable, without the definition below being limiting, are silane polysulphides corresponding to the general formula (V):

Z-A-Sₓ-A-Z (V)
in which:
   x is an integer from 2 to 8 (preferably from 2 to 5);
   the A symbols, which are identical or different, represent a divalent hydrocarbon radical (preferably a C₁-C₁₈ alkylene group or a C₆-C₁₂ arylene group, more particularly a C₁-C₁₀, especially C₁-C₄, alkylene, in particular propylene);
   the Z symbols, which are identical or different, correspond to one of the three formulae below:

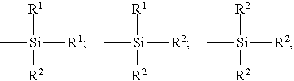

in which:
   the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl);
   the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, even more preferentially a group chosen from C₁-C₄ alkoxyls, in particular methoxyl and ethoxyl).

In the case of a mixture of alkoxysilane polysulphides corresponding to the above formula (I), especially customary commercially available mixtures, the mean value of “x” is a fractional number preferably of between 2 and 5, more preferentially close to 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂.

As coupling agent other than alkoxysilane polysulphide, mention will especially be made of bifunctional POSs (polyorganosiloxanes), or else of hydroxysilane polysulphides, such as described in patent applications WO 02/30939 (or U.S. Pat. No. 6,774,255) and WO 02/31041 (or US 2004/051210), or else of silanes or POSs bearing azodicarbonyl functional groups, such as described, for example, in patent applications WO 2006/125532, WO 2006/125533 and WO 2006/125534.

As coupling agent, mention may also be made of alkoxysilanes bearing an unsaturated carbon-based group capable of reacting, by the radical route, with a diene unit of the elastomer matrix. By way of example, mention may be made of 3-butene-triethoxysilane or 3-methacryloxypropyltrimethoxysilane.

The content of coupling agent is advantageously less than 20 phr (parts by weight per hundred parts of elastomer present in the rubber composition in question constituting one layer), it being understood that it is generally desirable to use as little as possible thereof. Typically, the content of coupling agent represents from 0.5% to 15% by weight relative to the amount of inorganic filler. Its content is preferentially between 0.5 and 12 phr, more preferentially within a range extending from 3 to 10 phr. This content is easily adjusted by those skilled in the art depending on the content of inorganic filler used in the diene rubber composition.

According to a particular embodiment of the invention, each of the diene rubber compositions constituting respectively the 3 layers of the laminate comprises a reinforcing filler, preferably a carbon black.

Content of Reinforcing Filler:

The content of reinforcing filler in each of the diene rubber compositions of the laminate may vary to a great extent, for example depending on the nature of the elastomer matrix or of the reinforcing filler in the diene rubber composition or depending on the amount of plasticizing agent in the diene rubber composition. These variables are adjusted by those skilled in the art as a function of the use made of the laminate, especially in a tire.

In the case of using a laminate in which the first layer of the laminate constitutes a tread intended to be fitted on a tire and the third layer constitutes a tread underlayer, the nature of the reinforcing filler in the diene rubber composition of the first layer and of the third layer, and also the content thereof, are chosen by those skilled in the art to be suitable for the particular conditions of this use. For example, the reinforcing filler may be a carbon black, a silica or a mixture thereof, the content thereof in the diene rubber composition being able to vary from 20 to 200 phr.

According to any one of the embodiments of the invention, the content of reinforcing filler in the diene rubber composition of the second layer preferably varies from 5 to 80 phr, more preferentially from 5 to 50 phr.

According to a particular embodiment of the invention, the diene rubber composition of the second layer comprises a content of reinforcing filler which is less than or equal to the content of reinforcing filler of the diene rubber composition of the first layer.

Other Additives:

The diene rubber composition constituting any one of the 3 layers may also contain, in addition to the coupling agents, coupling activators, agents for covering the inorganic fillers or more generally processing aids capable, in a known way, by virtue of an improvement in the dispersion of the filler in the rubber matrix and of a lowering of the viscosity of the diene rubber composition, of improving the ability thereof to be processed in the uncured state.

It may also comprise all or a portion of the usual additives customarily used in elastomer compositions intended to constitute mixtures of rubber finished articles such as tires, such as, for example, pigments, protective agents, such as antiozone waxes, chemical antiozonant, antioxidants, antifatigue agents, a crosslinking system, vulcanization accelerators or retardants, or vulcanization activators. When the elastomer matrix contains a terpolymer of ethylene, of α-olefin and of non-conjugated diene, in particular an EPDM, it is possible to use crosslinking coagents customarily used in the crosslinking of EPDMs. As crosslinking coagent, mention may be made of triallyl isocyanurate, ethylene dimethacrylate, or trimethylolpropane trimethacrylate. The crosslinking system is preferably based on sulphur but it may also be based on sulphur donors, on peroxide, on bismaleimide or on mixtures thereof.

The diene rubber compositions which constitute respectively the first layer, the second layer and the third layer preferably comprise a crosslinking system, preferably a vulcanization system.

The diene rubber compositions which may be used for the purposes of embodiments of the invention may also comprise plasticizing agents, for example extending oils of aromatic or non-aromatic nature, especially very slightly aromatic or non-aromatic oils (e.g. paraffinic or hydrogenated naphthenic oils, or MES or TDAE oils), vegetable oils, in particular glycerol esters such as glycerol trioleates, hydrocarbon-based plasticizing resins having a high Tg, preferably of greater than 30° C., such as those described, for example, in applications WO 2005/087859, WO 2006/061064 and WO 2007/017060. The content of plasticizing agent is adjusted by those skilled in the art as a function of the viscosity and of the properties sought for the diene rubber composition, which are determined by the use which will be made of the diene rubber composition. The viscosity of the diene rubber composition itself depends on numerous variables, such as the viscosity of the elastomer matrix, the content of reinforcing filler, the interactions which may exist between the elastomer matrix and its reinforcing filler. Thus, those skilled in the art, with their general knowledge, choose the suitable content of plasticizing agent while taking these different variables into account.

If the diene rubber composition of the second layer which may be used for the purposes of embodiments of the invention contains a plasticizing agent, it preferably contains at most 20 phr, more preferentially less than 10 phr, even more preferentially less than 5 phr thereof. These preferential embodiments make it possible to achieve very noteworthy levels of adhesion between the first and the third layer, by virtue of the interphase consisting of the second layer.

According to another embodiment of the invention, the diene rubber composition of the second layer does not contain plasticizing agent. This embodiment which is advantageous from the point of view of adhesion performance is particularly suited to the diene rubber compositions constituting the second layer which have a low content of filler, especially those which comprise at most 50 phr of reinforcing filler.

Preparation of the Diene Rubber Compositions:

The diene rubber compositions which may be used for the purposes of embodiments of the invention are manufactured in appropriate mixers, using two successive phases of preparation well known to those skilled in the art: a first phase of thermomechanical working or kneading (“non-productive” phase) at high temperature, up to a maximum temperature of between 130° C. and 200° C., followed by a second phase of mechanical working (“productive” phase) down to a lower temperature, typically below 110° C., for example between 40° C. and 100° C., finishing phase during which the crosslinking system is incorporated.

Preparation of the Laminate:

In the manufacture of the laminate in accordance with embodiments of the invention, the diene rubber compositions constituting the layers are affixed to one another in the uncured state. In order to facilitate interfacial adhesion, the layers are preferably applied under hot conditions, the layers being in the uncured state.

It will be readily understood that, depending on the specific fields of application, the laminate in accordance with embodiments of the invention may comprise several preferential thickness ranges. Thus, for example, for pneumatic tires of passenger vehicle type, the first layer and third layer may have a thickness of at least 2 mm, preferentially of between 3 and 10 mm. According to another example, for pneumatic tires for heavy-goods or agricultural vehicles, the preferential thickness may be between 2 and 20 mm for the first and third layers. According to another example, for pneumatic tires for vehicles in the field of civil engineering or for aeroplanes, the preferential thickness of the first and third layers may be between 2 and 100 mm.

According to any one of the embodiments of the invention, the second layer preferably has a thickness ranging from 60 μm to a few millimetres, for example from 100 μm to 5 mm. The thickness is adjusted as a function of the particular conditions of use of the laminate.

For the smallest thicknesses, in particular of the order of a few hundred μm, the layers are preferably formed by applying the diene rubber composition in the form of a dissolution composed of a volume of solvent. For greater thicknesses, preference is given to calendering or even extruding the diene rubber composition in the form of a layer.

In order to manufacture the laminate, the layers may be arranged on top of one another by successive application of the layers, for example on a building drum conventionally used in the manufacture of pneumatic tires (or tire casings). For example, the first layer is placed on the drum, the second layer on the first layer, the third layer on the second layer.

The laminate may either be in the uncured state (before crosslinking or vulcanization) or in the cured state (after crosslinking or vulcanization).

In the manufacture of a tire containing the laminate, the laminate may be manufactured prior to the manufacture of the tire or during the manufacture of the tire. In the former case, the laminate formed beforehand and in the uncured state may be applied to the tire by placing it for example on the carcass reinforcement or the crown reinforcement of the tire, also in the uncured state. In the second case, the third layer may be placed for example on the carcass reinforcement or the crown reinforcement of the tire, also in the uncured state, then the second layer placed on the third layer and the first layer on the second layer, the first, second and third layers being in the uncured state.

The laminate may be used in a tire, the tire comprising a tread, two sidewalls, two beads, a carcass reinforcement passing into the two sidewalls and anchored to the two beads, and a crown reinforcement arranged circumferentially between the tread and the carcass reinforcement.

According to one embodiment of the invention, the laminate is used in a tire such that the first layer constitutes a portion or all of the tire tread and the third layer constitutes a portion or all of a tread underlayer.

According to a preferential embodiment of the invention in which the laminate is used in a tire, the first layer constitutes all of the tread and the third layer constitutes all of a tread underlayer.

When the third layer in the laminate is used as a tire tread underlayer, it is preferably not intended to come into contact with the surface on which the tire runs.

The tire, which is provided with the laminate and which represents another subject of the invention, may be in the cured or uncured state.

The abovementioned features of embodiments of the present invention, and also others, will be better understood on reading the following description of several exemplary embodiments of the invention, given by way of nonlimiting illustration.

### EXEMPLARY EMBODIMENTS

1—Preparation of the Diene Rubber Compositions and Laminates:

The following procedure is used for the compositions, the formulation of which is shown in Table 1:

The elastomer, the reinforcing filler and also the various other ingredients, with the exception of the vulcanization system, are successively introduced into an internal mixer (final degree of filling: approximately 70% by volume), the initial vessel temperature of which is approximately 80° C. Thermomechanical working (non-productive phase) is then carried out in one step, which lasts in total approximately 3 to 4 min, until a maximum “dropping” temperature of 165° C. is reached. The mixture thus obtained is recovered and cooled and then sulphur and an accelerator of sulphenamide type are incorporated on a mixer (homofinisher) at 30° C., everything being mixed (productive phase) for an appropriate time (for example approximately ten minutes).

The compositions thus obtained are subsequently calendered in the form of slabs (thickness of 2 to 3 mm) or of layers for the measurement of their respective levels of adhesion.

Compositions C1, C2 and C3 differ by the nature of the elastomer matrix of which they are respectively composed.

Composition C1 represents the first layer of the laminate and contains an elastomer E1, EPDM with a low degree of unsaturation, comprising 5% by weight of diene units.

Composition C2 represents the second layer of the laminate and contains an elastomer E2 comprising ethylene units and diene units comprising a carbon-carbon double bond, which units are randomly distributed within the second elastomer.

Composition C3 represents the third layer of the laminate and contains a highly unsaturated elastomer E3, natural rubber.

2—Measurements and Tests Used:

2-a) Size Exclusion Chromatography

Size exclusion chromatography (SEC) is used. SEC makes it possible to separate macromolecules in solution according to their size through columns filled with a porous gel. The macromolecules are separated according to their hydrodynamic volume, the bulkiest being eluted first. Without being an absolute method, SEC makes it possible to comprehend the distribution of the molar masses of a polymer. The various number-average molar masses (Mn) and weight-average molar masses (Mw) can be determined from commercial standards and the polydispersity index (P1=Mw/Mn) can be calculated via a “Moore” calibration.

Preparation of the Polymer:

There is no specific treatment of the polymer sample before analysis. The latter is simply dissolved, in tetrahydrofuran+1 vol % of diisopropylamine+1 vol % of triethylamine+1 vol % of distilled water or in chloroform, at a concentration of approximately 1 g/l. The solution is then filtered through a filter with a porosity of 0.45 μm before injection.

SEC Analysis:

The apparatus used is a Waters Alliance chromatograph. The elution solvent is tetrahydrofuran+1 vol % of diisopropylamine+1 vol % of triethylamine or chloroform, according to the solvent used for the dissolution of the polymer. The flow rate is 0.7 ml/min, the temperature of the system is 35° C. and the analytical time is 90 min. A set of four Waters columns in series, with commercial names Styragel HMW7, Styragel HMW6E and two Styragel HT6E, is used.

The volume of the solution of the polymer sample injected is 100 μl. The detector is a Waters 2410 differential refractometer and the software for making use of the chromatographic data is the Waters Empower system.

The calculated average molar masses are relative to a calibration curve produced from PSS Ready Cal-Kit commercial polystyrene standards.

2-b) Adhesion Test

Adhesion is measured by a T-type peel test, also referred to as 180° peeling. The peeling test specimens are produced by bringing the two layers (the compositions constituting the layers being in the uncured state) for which the adhesion is to be tested into contact. An incipient crack is inserted between the two layers. Each of the layers is reinforced by a composite ply which limits the deformation of said layers under traction.

The test specimen, once assembled, is brought to 150° C. under a pressure of 16 bar, for 30 minutes. Strips with a width of 30 mm are then cut out using a cutting machine. The two sides of the incipient crack were subsequently placed in the jaws of a tensile testing device with the Instron brand name. The tests are carried out at 20° C. and at a pull speed of 100 mm/min. The tensile stresses are recorded and the latter are standardized by the width of the test specimen. A curve of strength per unit width (in N/mm) as a function of the movable crosshead displacement of the tensile testing machine (between 0 and 200 mm) is obtained.

The adhesion value selected corresponds to the propagation of the crack within the test specimen and thus to the mean stabilized value of the curve. The adhesion values of the examples are standardized relative to a control (base 100).

The adhesion is measured between the two layers C1 and C3, between the two layers C1 and C2, and between the two layers C2 and C3. The value of the measurement of adhesion between the two layers C1 and C3 is selected as the control value, since the laminate comprising just the two layers C1 and C3 is not in accordance with the invention due to the absence of the layer C2.

Table 2 presents the results obtained after peel tests at room temperature. The results are expressed as performance index. An index of greater than 100 indicates a greater improvement in adhesion.

It is observed that the performance indices of adhesion, on the one hand between the first layer and the second layer, and on the other hand between the second layer and the third layer, are the highest (700 and 625, respectively) relative to the control. The presence, in a laminate, of the second layer between the first layer and the third layer of the laminate makes it possible to very greatly increase the resistance of the laminate to the separation of the layers which constitute it, compared to the control laminate only comprising the layers C1 and C3.

TABLE 1

| | C1 | C2 | C3 |
|---|---|---|---|
| E1 (1) | 100 | — | — |
| E2 (2) | — | 100 | — |
| E3 (3) | — | — | 100 |
| Carbon black (4) | 30 | 30 | 30 |
| Antioxidant (5) | 1.5 | 1.5 | 1.5 |
| Stearic acid (6) | 2.5 | 2.5 | 2.5 |
| Zinc oxide (7) | 3 | 3 | 3 |
| Accelerator (8) | 2.0 | 2.0 | 2.0 |
| Sulphur | 1.0 | 1.0 | 1.0 |

(1) EPDM, Nordel IP 4570 from Dow
(2) Elastomer containing 71% units UA, 8% units UB, 14% units UC and 7% units UD (mol %), prepared according to a process for polymerization of ethylene and butadiene in accordance with example 4-2 of patent EP 1 954 705 B1 in the name of the applicants, the polymerization time being adjusted so as to obtain a molar mass Mn = 153 000 g/mol with a polydispersity index equal to 1.9; the content by weight of diene units being 45% by weight
(3) Natural rubber
(4) Carbon black of N234 grade according to Standard ASTM D-1765
(5) N-(1,3-Dimethylbutyl)-N-phenyl-para-phenylenediannine: Santoflex 6-PPD from Flexsys
(6) Stearin, Pristerene 4931 from Uniqenna
(7) Zinc oxide of industrial grade from Unnicore
(8) N-Cyclohexyl-2-benzothiazolesulphenannide, Santocure CBS from Flexsys

TABLE 2

| Interface between layers tested | C1/C3 | C2/C3 | C2/C1 |
|---|---|---|---|
| Level of adhesion | 100 | 625 | 700 |

1. An elastomer laminate comprising 3 layers,
the first layer consisting of a diene rubber composition comprising a first elastomer matrix,
the second layer consisting of a diene rubber composition comprising a second elastomer matrix, which second elastomer matrix comprises a second elastomer comprising ethylene units and diene units comprising a carbon-carbon double bond, which units are randomly distributed within the second elastomer,
the third layer consisting of a diene rubber composition comprising a third diene elastomer having a content by weight of diene units of greater than 50%,
the second layer being arranged between the first layer and the third layer.

2. An elastomer laminate according to claim 1, in which the ethylene units represent at least 50 mol % of all the monomer units of the second elastomer.

3. An elastomer laminate according to claim 2, in which the second elastomer comprises the following units UA, UB, UC and UD randomly distributed within the second elastomer,
UA) —CH₂—CH₂— according to a molar percentage of m %
UB) according to a molar percentage of n % 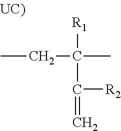
according to a molar percentage of o % 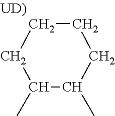
according to a molar percentage of p %
R₁ and R₂, which are identical or different, denoting a hydrogen atom, a methyl radical or a phenyl radical which is unsubstituted or substituted in the ortho, meta or para position by a methyl radical,
m≧50
0<o+p≦25
n+o>0
m, n, o and p being numbers ranging from 0 to 100
the respective molar percentages of m, n, o and p being calculated on the basis of the sum of m+n+o+p, which is equal to 100.

4. An elastomer laminate according to claim 3, in which the second elastomer contains units UE randomly distributed within the second elastomer, 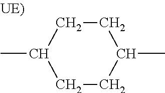
according to a molar percentage of q %
o+p+q≧10
q≧0
the respective molar percentages of m, n, o, p and q being calculated on the basis of the sum of m+n+o+p+q, which is equal to 100.

5. An elastomer laminate according to claim 3, in which the second elastomer contains units UF randomly distributed within the second elastomer, 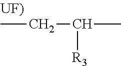
according to a molar percentage of r %
R₃ denoting an alkyl radical having from 1 to 4 carbon atoms or an aryl radical,
0≦r≦25.
the respective molar percentages of m, n, o, p, q and r being calculated on the basis of the sum of m+n+o+p+q+r, which is equal to 100.

6. An elastomer laminate according to claim 5, in which r is equal to 0.

7. An elastomer laminate according to claim 3, in which at least one of the two molar percentages p and q is different from 0.

8. An elastomer laminate according to claim 3, in which p is strictly greater than 0.

9. An elastomer laminate according to claim 3, in which the second elastomer has at least one of the following criteria:
m≧65
n+o+p+q≧15
10≧p+q≧2
1≧n/(o+p+q)
when q is non-zero, 20≧p/q≧1.

10. An elastomer laminate according to claim 3 in which the second elastomer contains, as monomer units, only the units UA, UB, UC, UD and UE according to their respective molar percentages m, n, o, p and q.

11. An elastomer laminate according to claim 3, in which the second elastomer contains, as monomer units, only the units UA, UB, UC and UD according to their respective molar percentages m, n, o and p.

12. An elastomer laminate according to claim 3, in which R₁ and R₂ are identical and denote a hydrogen atom.

13. An elastomer laminate according to, claim 1 in which the first elastomer matrix comprises a first terpolymeric elastomer of ethylene, of an α-olefin and of a non-conjugated diene.

14. An elastomer laminate according to claim 13, in which the first elastomer is an EPDM.

15. An elastomer laminate according to claim 13, in which the first elastomer has a content by weight of diene units which is less than the content by weight of diene units of the second elastomer.

16. An elastomer laminate according to, claim 13 in which the first elastomer has a content by weight of diene units of less than 10%.

17. An elastomer laminate according to, claim 13 in which the first elastomer represents more than 50% by weight of the first elastomer matrix.

18. An elastomer laminate according to, claim 1 in which the first elastomer matrix has a content by weight of diene units which is less than the content by weight of diene units of the second elastomer.

19. An elastomer laminate according to claim 1, in which the first elastomer matrix has less than 10% by weight of diene units.

20. An elastomer laminate according to claim 1, in which the second elastomer matrix comprises another highly unsaturated diene elastomer.

21. An elastomer laminate according to claim 20, in which the second elastomer matrix consists of the second elastomer and the other highly unsaturated diene elastomer.

22. An elastomer laminate according to claim 20, in which the other highly unsaturated diene elastomer is a polyisoprene.

23. An elastomer laminate according to claim 1, in which the second elastomer represents more than 50% by weight of the second elastomer matrix.

24. An elastomer laminate according to claim 1, in which the second elastomer represents all of the second elastomer matrix.

25. An elastomer laminate according to claim 1 in which the third diene elastomer comprises monomeric 1,3-diene units, preferably isoprene.

26. An elastomer laminate according to claim 25, in which the third diene elastomer is a polyisoprene.

27. An elastomer laminate according to claim 1, in which the third diene elastomer represents at least 95% by weight of the elastomer matrix which constitutes the diene rubber composition of the third layer.

28. An elastomer laminate according to claim 1, in which the diene rubber composition which constitutes any one of the 3 layers comprises a reinforcing filler.

29. An elastomer laminate according to claim 28, in which the diene rubber compositions which constitute respectively the first layer, the second layer and the third layer comprise a reinforcing filler.

30. An elastomer laminate according to claim 1, in which the diene rubber composition which constitutes any one of the 3 layers comprises a crosslinking system.

31. An elastomer laminate according to claim 30, in which the diene rubber compositions which constitute respectively the first layer, the second layer and the third layer comprise a crosslinking system.

32. An elastomer laminate according to claim 1, in which the diene rubber composition of the second layer contains at most 20 phr of plasticizing agent.

33. An elastomer laminate according to claim 1, in which the diene rubber composition of the second layer does not contain plasticizing agent.

34. A tire including an elastomer laminate defined according to claim 1.

35. A tire comprising a tread, two sidewalls, two beads, a carcass reinforcement passing into the two sidewalls and anchored to the two beads, and a crown reinforcement arranged circumferentially between the tread and the carcass reinforcement, which tire comprises a laminate according to claim 1.

36. A tire according to claim 35, in which the first layer of the laminate constitutes a portion or all of the tire tread and the third layer of the laminate constitutes a portion or all of a tread underlayer.

37. An adhesive composition to adhere two compositions, characterized in that the adhesive composition is
a diene rubber composition comprising a second elastomer matrix, which second elastomer matrix comprises a second elastomer comprising ethylene units and diene units comprising a carbon-carbon double bond, which units are randomly distributed within the second elastomer, and that the two compositions to be adhered are respectively identical to the diene rubber compositions constituting the first layer and the third layer defined according to claim 1.
